(19) United States
(12) Patent Application Publication
(10) Pub. No.: US 2016/0217874 A1
(43) Pub. Date: Jul. 28, 2016

(54) Molten Salt Reactor

(71) Applicant: TRANSATOMIC POWER CORPORATION, Cambridge, MA (US)

(72) Inventors: Leslie C. Dewan, Cambridge, MA (US); Mark Massie, Cambridge, MA (US)

(21) Appl. No.: 15/025,121

(22) PCT Filed: Sep. 26, 2014
(86) PCT No.: PCT/US14/57655

§ 371 Date: Mar. 25, 2016

Related U.S. Application Data
(60) Provisional application No. 61/883,834, filed on Sep. 27, 2013.
(60) Provisional application No. 61/883,834, filed on Sep. 27, 2013.

(51) Int. Cl. G21C 3/54; G21C 1/03; G21C 1/22; G21C 5/12; G21C 7/04

(52) U.S. Cl. CPC G21C 3/54; G21C 5/12; G21C 7/04; G21C 1/22; G21C 1/03

(57) ABSTRACT

A molten salt reactor includes: a fluoride fuel salt; and a metal hydride moderator.

### TECHNICAL FIELD

This disclosure relates to nuclear reactors, and more particularly to molten salt reactors.

### BACKGROUND

Thermal-spectrum molten salt reactors have long interested the nuclear engineering community because of their many safety benefits—passive shutdown ability, low pressure piping, negative void and temperature coefficients, and chemically stable coolants—as well as their scalability to a wide range of power outputs. They were originally developed at the Oak Ridge National Laboratory (ORNL) in the 1950s, 1960s, and 1970s, and working versions were shown to operate as designed [1].

The bulk of the early work on these designs focused on component lifetime—specifically, developing alloys able to maintain their mechanical and material integrity in a corrosive, radioactive salt environment. Experimental tests running over several years at ORNL in the 1960s and 1970s showed that modified Hastelloy-N possesses the necessary chemical and radiation stability for long-term use in molten salt reactors. Despite this progress, the USA remained focused on light-water reactors for commercial use, primarily due to extensive previous experience with naval water-cooled reactors. Advocates of thorium and increasing demand for small modular reactors drove renewed examination of molten salt in the 1990s. In 2002, the multinational Generation IV International Forum (GIF) reviewed approximately one hundred of the latest reactor concepts and selected molten salt reactors as one of the six advanced reactor types most likely to shape the future of nuclear energy “due to advances in sustainability, economics, safety, reliability and proliferation-resistance” [2].

### SUMMARY

An advanced molten salt reactor that generates clean, passively safe, proliferation-resistant, and low-cost nuclear power. This reactor can consume the spent nuclear fuel (SNF) generated by commercial light water reactors or use freshly mined uranium at enrichment levels as low as 1.8% U-235. It achieves actinide burnups as high as 96%, and can generate up to 75 times more electricity per ton of mined uranium than a light-water reactor.

Key characteristics of a first commercial plant are as follows:

| | |
|---|---|
| Reactor Type | Molten Salt Fueled Reactor |
| Fuel | Uranium or spent nuclear fuel (SNF) |
| Salt | LiF-(Heavy Metal)F₄ |
| Moderator | Zirconium Hydride |
| Neutron Spectrum | Thermal |
| Thermal Capacity | 1250 MWth |
| Gross Electric Capacity | 550 MWe |
| Net Electric Capacity | 520 MWe |
| Outlet Temperature | 650° C. |
| Gross Thermal | 44% using steam cycle with reheat |
| Efficiency | |
| Fuel Efficiency | 75X higher per MW than LWR |
| Long-lived Actinide | Up to 96% less per MW than LWR |
| Waste | |
| Station Blackout Safety | Walkaway safe without outside intervention |
| Overnight Cost | $2 billion |
| Mode of Operation | Typically for base load; |
| | May be used for load following |

Transatomic Power has greatly improved the molten salt concept, while retaining its significant safety benefits. The main technical change we make is to combine a moderator and fuel salt that have not previously been used together in molten salt reactors: a zirconium hydride moderator with a LiF-(Heavy metal)F4 fuel salt. Together, these components generate a neutron spectrum that allows the reactor to run using fresh uranium fuel with enrichment levels as low as 1.8% U-235, or using the entire actinide component of spent nuclear fuel (SNF). Previous molten salt reactors such as the ORNL Molten Salt Reactor Experiment (MSRE) relied on high-enriched uranium, with 33% U-235 [1]. Enrichments this high are no longer permitted in commercial nuclear power plants.

Transatomic Power's design also enables extremely high burnups—up to 96%—over long time periods. The reactor can therefore run for decades and slowly consume the actinide waste in its initial fuel load. Furthermore, our neutron spectrum remains primarily in the thermal range used by existing commercial reactors. We therefore avoid the more severe radiation damage effects faced by fast reactors, as thermal neutrons do comparatively less damage to structural materials.

Some radioactive materials release neutrons. When a neutron strikes a fissile atom, such as U-235, at the right speed, the atom can undergo “fission” or break into smaller pieces, which are called fission products, and produce free neutrons. Fission breaks bonds among the protons and neutrons in the nucleus, and therefore releases vast amounts of energy from a relatively small amount of fuel. Much of this energy is in the form of heat, which can then be converted into electricity or used directly as process heat.

Most neutrons travel too quickly to cause fission. In a typical nuclear reactor, the fuel is placed near a moderator. When neutrons hit the moderator they slow down, which makes them more likely to cause fission in uranium. If the average number of free neutrons remains constant over time, the process is self-sustaining and the reactor is said to be critical.

Despite the use of the word critical, there is no chance of an atomic explosion in nuclear power plants. The fuel used in civilian nuclear reactors has a low enrichment level that is simply not capable of achieving the chain reaction required for an atomic explosion. The main concern in nuclear power is to avoid a steam explosion, fire, or containment breach that could allow the release of radioactive materials outside the plant and affect public health.

Light-water nuclear reactors—the most prevalent kind of reactor in use today—are fueled by rods filled with solid uranium oxide pellets. The fuel rods are submerged in water. Water is a moderator that slows neutrons to the correct speed to induce fission in the uranium, thereby heating up the rods. The water also carries heat away from the rods and into a steam turbine system to produce electricity. A key problem with water is risk of steam explosion if the reactor's pressure boundary or cooling fails.

In a molten salt reactor, a radioactive fuel such as uranium or thorium is dissolved into fluoride or chloride salts to form a solution that we call a “fuel salt.” The fuel salt is normally an immobile solid material, but when heated above approximately 500° C., it becomes a liquid that flows. Thus it is the liquid fuel salt, rather than water, that carries the heat out of the reactor. The plant can operate near atmospheric pressure with a coolant that returns to a solid form at ambient temperatures. This feature simplifies the plant and assures greater safety for the public.

Molten salt reactors are quite different from sodium fast reactors, even though many people think of sodium when they hear of salt. The sodium metals used by those reactors can release a hydrogen byproduct that is combustible in the presence of air or water. Our fluoride salts remove this fire risk, while further simplifying and increasing the safety of the plant design.

A version of our reactor can also operate using thorium fuel. Thorium has special merit as a nuclear fuel due to its generally shorter-lived waste and higher potential burn-up. The TAP reactor can also achieve the same benefits from uranium, which has an existing industrial base. Using uranium also lets us create a reactor that can slowly consume the world's existing stockpiles of spent nuclear fuel and, potentially, stockpiles of plutonium as well, thereby providing a great benefit to society.

The details of one or more embodiments of the invention are set forth in the accompanying drawings and the description below. Other features, objects, and advantages will be apparent from the description and drawings, and from the claims.

### DESCRIPTION OF DRAWINGS

FIG. 1 is a schematic of the TAP reactor, showing the reactor vessel, primary loop, intermediate loop, and drain tanks.

FIG. 2 is a simplified reactor schematic, showing the primary loop, intermediate loop, drain tank, and outlet to the fission gas processing system.

FIG. 3 is a temperature profile of a light water reactor's solid fuel pin, from center to edge.

FIG. 4 shows decay heat density in an LWR and a TAP reactor.

FIG. 5 is a cooling curve for fuel salt in auxiliary tank with 25 MW of cooling.

FIG. 6 compares temperature progression effects for a light water reactor (LWR) and a TAP reactor.

FIG. 7 compares the neutron spectrum in a zirconium hydride moderated TAP reactor, a graphite moderated molten salt reactor, and a fast spectrum molten salt reactor.

FIG. 8 compares electricity production per metric ton of natural uranium in a light water reactor and a TAP reactor.

FIG. 9 compares mass percentages of important actinides as a function of time in a TAP reactor.

FIG. 10 plots the multiplication factor of an infinite lattice of varying moderator and fuel-salt volume fractions.

FIG. 11 shows the effect of enrichment (fissile concentration) on burnup as a function of conversion ratio.

FIG. 12 plots conversion ratio as a function of fuel-salt volume fraction.

FIG. 13 is a schematic of a two-region reactor core.

FIG. 14 is a schematic of a two-region core with central unmoderated region.

FIG. 15 is a schematic of a three region core with two distinct ratios of fuel-salt to moderator volumes.

FIG. 16 is a schematic of a three region core with three distinct ratios of fuel-salt to moderator volumes.

Like reference symbols in the various drawings indicate like elements.

### DETAILED DESCRIPTION

Reactor Description and Design Considerations

We begin by describing the components of the TAP reactor that are within and adjacent to the nuclear island and discuss design considerations. We show a rendering and schematic of the nuclear island, describe the benefits of liquid fuel as compared to solid fuel, and then review the zirconium hydride moderator, corrosion, reactor neutronics, and waste stream.

Nuclear Island Rendering and Schematic

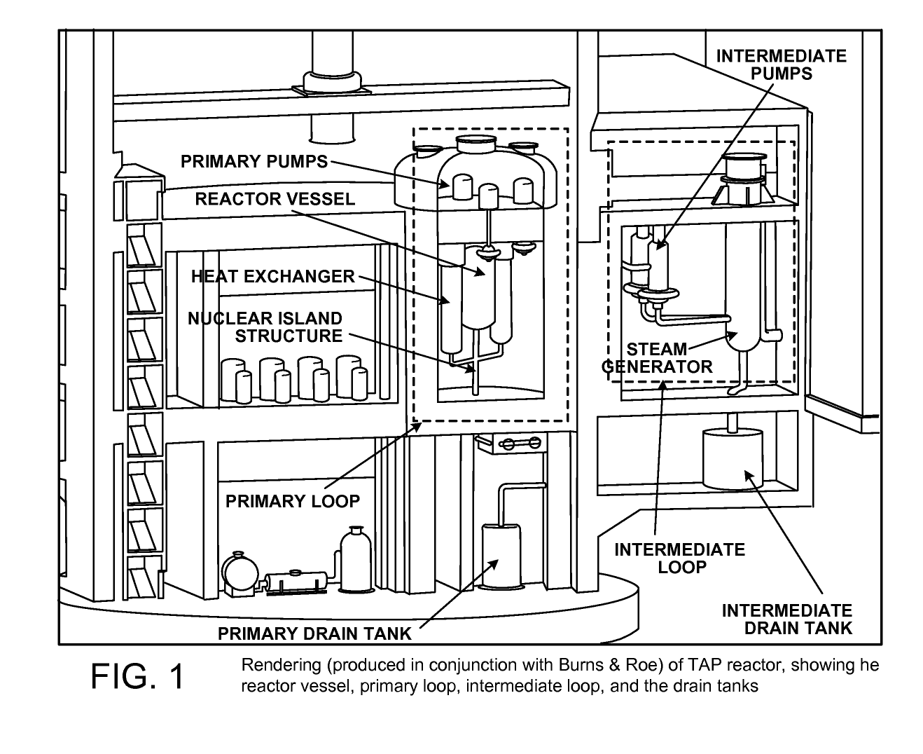

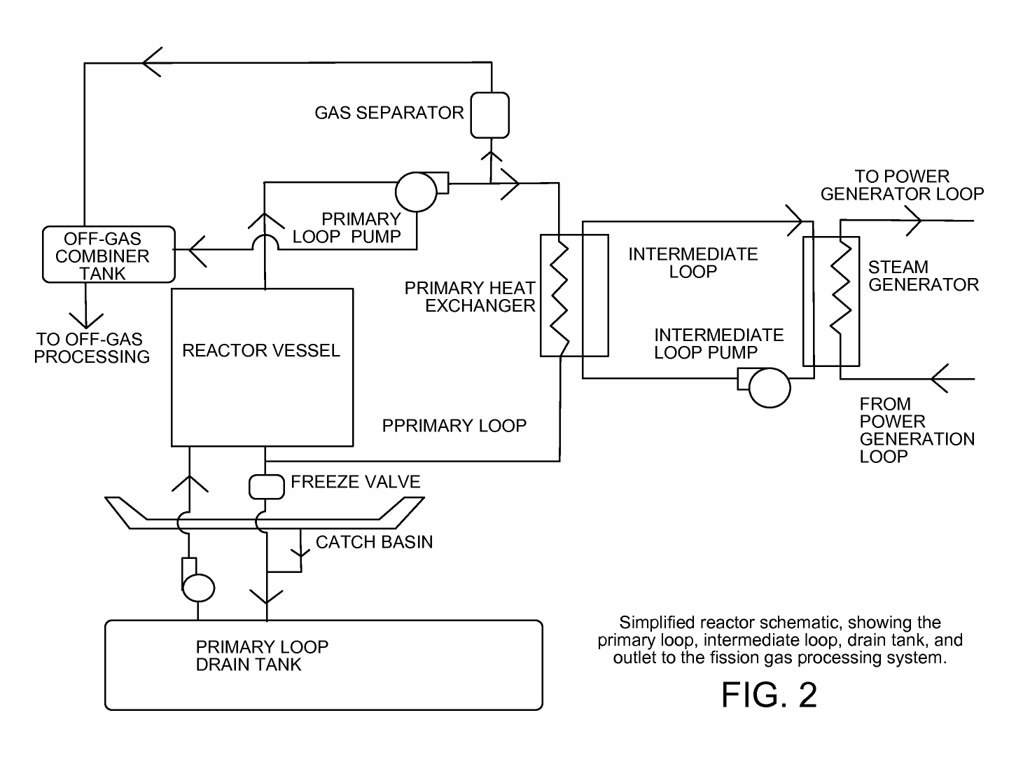

FIG. 1 shows a rendering of the TAP reactor seated in a concrete nuclear island structure for a 520 MWe nuclear power plant incorporating a TAP reactor. This same system is shown schematically in FIG. 2.

The reactor's primary loop contains the reactor vessel (including the zirconium hydride moderator), pumps, and primary heat exchanger. Pumps continuously circulate the LiF-(Heavy metal)F4 fuel salt through the primary loop. The pumps, vessels, tanks, and piping are made of modified Hastelloy-N, which is highly resistant to radiation and corrosion in molten salt environments. Within the reactor vessel, in close proximity to the zirconium hydride moderator, the fuel salt is in a critical configuration and steadily generates heat.

The heat generated in the primary loop is transferred via heat exchangers into intermediate loops filled with molten LiF—KF—Na—F (FLiNaK) salt, which does not contain radioactive materials. The intermediate loops in turn transfer heat to the steam generators. The intermediate loops therefore physically separate the nuclear material from the steam systems, adding an extra layer of protection against radioactive release.

The steam generators use the heat from the intermediate loop to boil water into steam, which is then fed into a separate building that houses the turbine. The reactor runs at a higher temperature than conventional reactors—the salt exiting the reactor core is approximately 650° C., whereas the core exit temperature for water in a light water reactor is only about 330° C. (for a pressurized water reactor) or 290° C. (for a boiling water reactor). The thermal efficiency when connected to a standard steam cycle is 44%, as compared to 34% in a typical light-water reactor. The higher efficiency directly reduces cost because it permits smaller turbines—turbines are a major expense for nuclear power plants.

The nuclear island also contains fission product removal systems. The majority of fission product poisons are continuously removed via an off-gas system (not shown in FIG. 1). As these byproducts are gradually removed, a small amount of fuel (either SNF or low-enriched fresh fuel) is regularly added to the primary loop. This process maintains a constant fuel mass, and allows the reactor to remain critical for decades. Through continuous fueling and filtering of key fission product poisons we are able to process the initial fuel load in the reactor for long periods of time, on the order of decades, as compared to a typical 4 year lifetime in a light water reactor. During this time, nearly all of the actinide fuel is converted into fission products and energy.

Liquid Fuel vs. Solid Fuel

Nearly all currently operating commercial reactors use solid uranium oxide as fuel. The uranium oxide, which is in the form of solid pellets, is surrounded by a metal cladding that helps the fuel retain its shape within the reactor. In contrast, Transatomic Power's reactor uses liquid fuel instead of solid fuel pins. We dissolve uranium (or SNF) in a molten fluoride salt, which acts as both fuel and coolant.

Liquid fuel offers significant advantages during normal operation. Primarily, it allows for higher reactor outlet temperatures, which lead to higher overall thermal efficiency for the plant.

Higher Outlet Temperatures

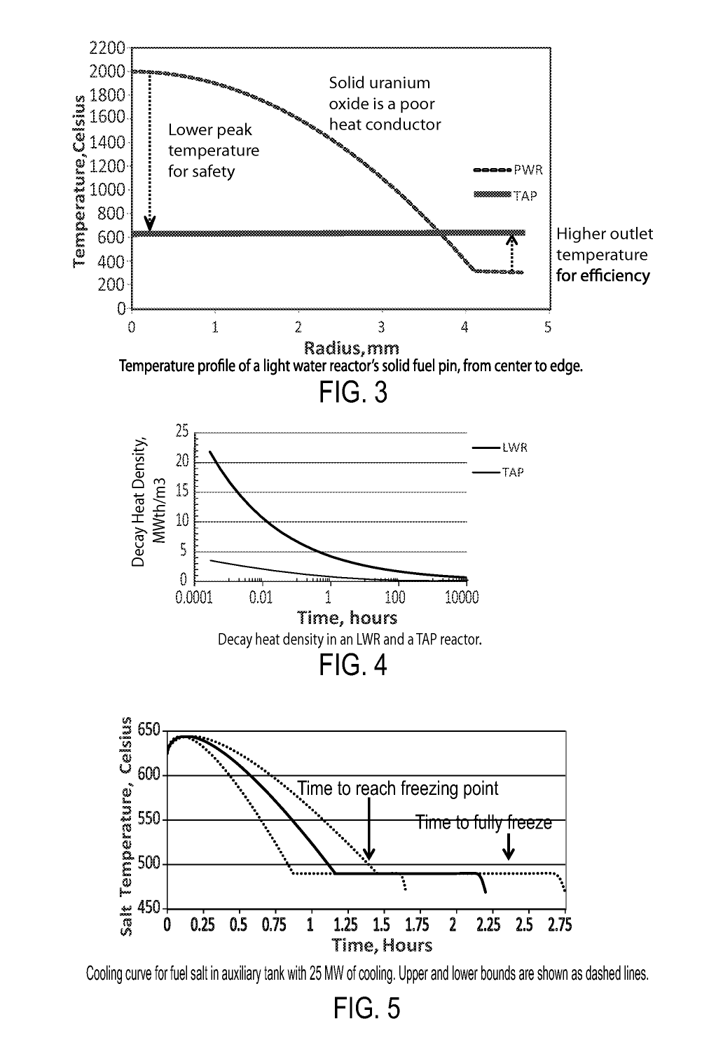

In a commercial light water reactor, water is used as a working fluid to carry the heat away from the hot outer surface of the fuel cladding, typically at about 330° C., to the plant's power loop. A higher cladding temperature allows for a higher water temperature, which allows for a more efficient power production cycle. A problem with solid fueled reactors, however, is that the uranium oxide material is a poor heat conductor. As shown in FIG. 3, the centerline temperature of the fuel pin must be very high—up to 2000° C. in a pressurized water reactor (PWR)—to generate an acceptably high temperature on the outer wall of the cladding. In most light water reactors, it is not possible to increase the outer cladding temperature significantly beyond 330° C., because that would result in an unacceptably high fuel centerline temperature.

A liquid-fueled reactor does not have these problems, because the fuel and coolant are the same material. The fuel salt is a good heat conductor, and therefore can have both a lower peak temperature and a higher outlet temperature than a solid fueled reactor.

Decay Heat is Better Distributed

One major safety advantage of liquid fuel is that it is significantly easier to cool it down during an accident scenario, as compared to solid fuel. Adequately cooling the fuel is crucial during an accident, because the fuel continues to produce decay heat even after the system becomes subcritical.

The fuel in Transatomic Power's reactor is dissolved and diluted across a substantial mass of salt, which distributes the decay heat and allows for easier cooling than an equivalently-sized solid fueled reactor. FIG. 4 compares the decay heat density (MWth of decay heat per cubic meter of fuel) in a TAP reactor and an LWR over time.

The TAP reactor's lower decay heat density makes it easier to contain and cool the liquid fuel during an accident.

Easier to Remove Decay Heat

Solid fueled reactors must bring coolant to their fuel in an accident scenario. If either coolant or cooling power is lost, decay heat production can quickly raise the reactor core temperature to levels high enough to severely damage its structure.

Light-water reactors were originally invented for use in submarines, which can use the ocean as an effectively infinite heat sink. On land, commercial power plants must reserve enough water in tanks and enough battery power in pumps to sustain emergency cooling for approximately a day, until help can arrive with more water and power. The most advanced plants now being built in the US will be able to extend the self-sufficiency period to 72 hours. However, local aid may or may not be available by then. As recent events at Fukushima demonstrated, a breakdown in transportation infrastructure to deliver emergency assistance can greatly exacerbate a reactor accident.

Unlike solid fueled reactors, liquid fueled reactors can drain fuel directly out of the core. This drainage can happen quickly, without pumping, through the use of passive safety valves and the force of gravity. One such passively safe drainage mechanism, called the freeze valve, was tested repeatedly with success during the ORNL MSRE [1]. A freeze valve consists of a drain in the reactor leading to a pipe that is plugged by a solid core of salt. The salt remains solid via electric cooling. If the reactor loses external electric power, the cooling stops, the plug melts, and fluoride salt drains out of the reactor core into an auxiliary containment vessel. Fission ceases because the fuel is separated from the moderator and because of the relatively high surface area geometry of the auxiliary tank. The high surface area to volume ratio in the auxiliary tank allows molten salt reactors to effectively change their fuel geometry to speed cooling after an accident.

The decay heat of the auxiliary tank is low enough to be removed by natural convection via a cooling stack, thereby eliminating the need for electrically-pumped coolant. A NaK cooling loop in the auxiliary tank is connected to a stack and allows for 25 MW of passive cooling to the fuel, adequate to air-cool the entire fuel salt inventory from liquid to solid state within 1.5 to 3 hours without outside power or coolant. FIG. 5 shows the temperature of the fuel salt inventory in the auxiliary tank as a function of time with 25 MW of cooling. The upper and lower bounds for the cooling curve are shown as dashed lines. Thermal data for the salt is based on molecular dynamics simulations [3] and extrapolated experimental data [4].

Slower and Less Catastrophic Accident Progression

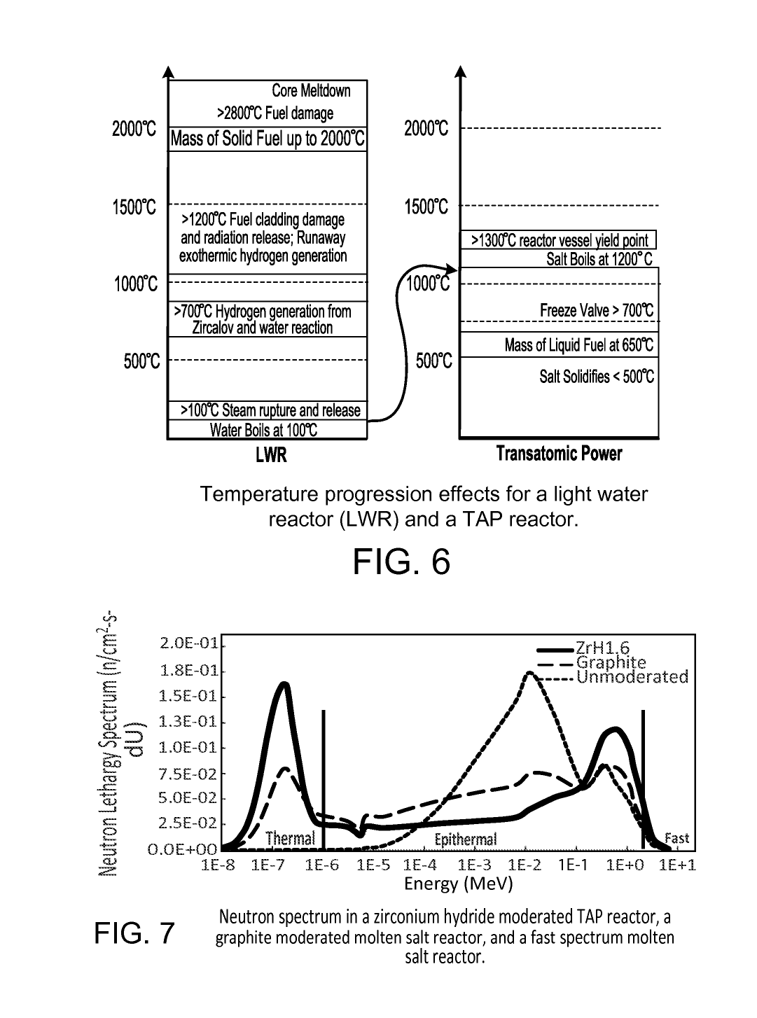

FIG. 6 shows the different consequences of unchecked fuel heating in an LWR and a TAP reactor. As shown in the “LWR” column of FIG. 6, partial cooling is helpful but not sufficient in an accident scenario. Even after the reactor becomes subcritical, the fuel pins continue to generate heat from delayed neutron interactions.

The risk of a steam flash or rupture and release exists during accidents at any temperature above 100° C., the boiling point of water at atmospheric pressure. Starting at approximately 700° C., Zircaloy and water together generate significant amounts of hydrogen. The reaction becomes exothermic above 1200° C., as the reaction produces heat more quickly than it can be removed—this further raises temperatures and runs counter to cooling efforts. The hydrogen generation can lead to a fire or explosion (as happened at Fukushima), and damage to the cladding releases radioactive materials that could travel away from the plant if they escape containment. Steam and fire are driving forces that increase the distance such materials could travel.

After an emergency, these overheating accident scenarios can develop within a few hours. A light-water reactor core, filled with solid fuel pins that are poor heat conductors, requires a cooling period of months or years to reach a stable cladding temperature of 100° C. or below. This mismatched timing—hours to overheat versus many months to cool off—is what makes nuclear safety for light-water reactors enormously challenging, and leaves these reactors particularly vulnerable to disasters that were not anticipated at the design stage, known as “beyond design basis” accidents.

Molten salt reactors avoid these issues inherently—by their choice of materials. As shown in the “Transatomic Power” column in FIG. 6, a molten salt reactor operates at a peak temperature of 650-700° C., far below the salt's boiling point of approximately 1200° C. The reactor's steady-state operation is already in the “green” zone. The thermal mass of the fuel is now an asset instead of a challenge, because it serves to resist any sudden heat increase. If the reactor temperature were to climb, temperatures greater than 700° C. passively melt a freeze valve (discussed in the “Better Inherent Safety” section of this paper), which drains fuel from the reactor and allows it to flow into a subcritical configuration with a high surface area. The subcritical molten salt still generates decay heat, but the high surface area allows it to readily cool down via natural convection and conduction.

At the other end of the temperature spectrum, the salt safely freezes in place if temperatures drop below 500° C. Unlike water, the salt becomes denser after it freezes, so this condition does not increase system pressure. As the TAP reactor operates at atmospheric pressure and has few conditions that could create strong driving forces, the solid salt is likely to remain safely in containment and within the exclusion zone of the plant.

In addition to the inherent safety benefits of molten salt liquid fuel, the TAP plant design has additional safety features and containment strategies for defense in depth. These safety features and strategies are discussed further below.

Salt Formulation

The vast majority of past work on molten salt reactors has used a lithium-beryllium-fluoride salt, called FLiBe. Transatomic Power's reactor instead uses LiF-(Heavy metal)F4 fuel salt. One known drawback of this salt is that its melting point is higher than that of FLiBe, and thus the primary loop piping must be carefully designed to avoid cold spots that could restrict flow and induce freezing in the salt. We chose to accept this engineering challenge for two reasons.

The first reason is that FLiBe contains beryllium. A small fraction of the population is hypersensitive to this material, and even trace amounts of beryllium can induce the chronic lung disease berylliosis in these people. We therefore choose a fuel salt that does not contain beryllium.

The second reason is that LiF-(Heavy metal)F4 is capable of containing a higher concentration of uranium than FLiBe salt. Therefore, each liter of our fuel salt has a higher amount of uranium than would be possible using FLiBe. This salt composition thus helps us operate using low-enriched fuels, as well as spent nuclear fuel.

Zirconium Hydride Moderator

A key difference between Transatomic Power's reactor and other molten salt reactors is its zirconium hydride moderator, which we use instead of a conventional graphite moderator. The reactor's critical region contains zirconium hydride rods. These rods are surrounded by cladding to extend the life of the moderator in the corrosive molten salt.

The available experimental data suggest that the service lifetime of the moderator rods will be at least 4 years. Additional in situ testing is needed to determine how far that lifetime can be extended. Ultimately, it may not be necessary to replace the zirconium hydride moderator assemblies over the lifetime of the plant. Our first design provides for maintenance access to the rods for evaluation and replacement, although this feature may be eliminated in a future version.

Using this moderator is an important advancement. Early molten salt reactors, such as the MSRE, used a graphite moderator that would shrink and swell over time under irradiation [1]. These dimensional changes not only reduced mechanical integrity, they also complicated reactor operation, since the degree of change and quality of moderation varied over time and spatially within the core. This variability made it necessary to replace the graphite every 4 years. In contrast, zirconium hydride moderator rods experience substantially less volumetric change than graphite under neutron irradiation [5].

In the design for the ORNL Molten Salt Breeder Reactor, 80-90% of the core volume was occupied by the graphite, leaving only 10%-20% of the core for fuel salt. It was therefore necessary to enrich the uranium in the fuel salt to 33% U-235 [1]. This high enrichment level was acceptable for a US national lab experiment; however, it is above modern limits of 20% U-235 for research reactors and well above the 3-5% U-235 enrichment level that is typical of commercial power reactors. Higher enrichments are discouraged as a proliferation concern.

By comparison, zirconium hydride's high hydrogen density allows it to achieve the same amount of thermalization as graphite in a much smaller volume. The zirconium hydride moderator therefore allows us to significantly reduce the reactor core volume, thereby reducing the size and cost of the reactor vessel and the volume of fuel salt. In Transatomic Power's reactor, only about 50% of the core volume is moderator, which gives us room for five times more fuel salt in the same size core, allowing better performance, reduced enrichment, and lower cost.

Co-optimizing the core geometry with the new moderator and new salt formulation, we can drop the minimum fuel enrichment level from 33% to 1.8%. This efficiency also enables us to consume SNF.

One of the factors we examined in selecting a zirconium hydride moderator is the stability of hydrogen in zirconium hydride at high temperature and under irradiation. The available data are extensive, and show that zirconium hydride is stable at the temperatures and neutron fluxes present in Transatomic Power's reactor [6-10]. The Soviet TOPAZ reactors, which generated thermionic power for satellites, demonstrated the effectiveness of their zirconium hydride moderator in experimental tests on the ground and in orbit [11]. According to experimental tests performed in conjunction with the TRIGA [6] and SNAP [7] reactors, both of which used uranium zirconium hydride fuel, zirconium hydride remains stable in a reactor core at temperatures at least up to 750° C. According to Simnad, “ . . . zirconium hydride can be used at temperatures as high as 750° C. under steady-state and 1200° C. under short transient pulse operation” [6].

Modest hydrogen redistribution may occur within the moderator, because there exists a temperature gradient within the moderator rod. The moderator is internally heated through gamma heating and neutron scattering, and the centerline temperature of the moderator rod will therefore be approximately 50° C. higher than the wall temperature. Some experimental data are available for temperature gradient-driven hydrogen diffusion in zirconium hydride. Huangs et al. tested a temperature gradient of 140° C. in a ZrH1.6 rod, with a centerline temperature of 645° C. and a surface temperature of 505° C. [8]. Their steady-state result showed ZrH1.7 on the surface and ZrH1.5 at the centerline [8]. Our research indicates that this hydrogen concentration gradient, or even a gradient several times larger than this, would not be detrimental to reactor function.

Additional work by Ponomarev-Stepnoi et al., in which zirconium hydride blocks were thermally cycled up to 650° C., found “statistically negligible” hydrogen emission after 4.1 years, and a maximum of 2% emission after 10 years of thermal cycling [9].

We conclude that significant hydrogen outgassing will not occur in this reactor under normal operation. If significant hydrogen outgassing does occur through some unknown condition, the zirconium hydride moderator becomes less effective (because of the lower amount of hydrogen present), and thereby reduces reactivity in the core. Zirconium on its own essentially does not moderate neutrons. Free hydrogen diffuses through the cladding and into the salt, where it bubbles out and is removed continuously by the outgas system. This feature bears some similarity to the inherent safety of uranium-hydrogen fuel used in TRIGA reactors, and represents an added safety benefit over previous molten salt reactors. Even in an extreme accident scenario, including failure of the off-gas removal, the system is designed so that the hydrogen concentration is never high enough to lead to a hydrogen explosion.

Corrosion

The reactor's primary loop piping, reactor vessel, valves, pumps, and heat exchangers are made with modified Hastelloy-N. This alloy is corrosion-tolerant in molten salt environments.

Hastelloy-N and modified Hastelloy-N were developed specifically for molten fluoride systems, and have generally good corrosion resistance in molten fluoride salt environments [12]. The Molten Salt Breeder Reactor (MSBR) project at the Oak Ridge National Laboratory concluded that modified Hastelloy-N is a suitable material for molten salt reactors from a corrosion standpoint [12]. Furthermore, MSBR research concluded that modified Hastelloy-N suffers much less radiation embrittlement than unmodified Hastelloy-N, the previous formulation of the alloy used in the MSRE [12]. Aside from the reduced radiation embrittlement, the material properties of modified Hastelloy-N are, according to MSBR research, “generally better” than those of Hastelloy-N [12].

There are some additional concerns related to the mechanical integrity of the primary loop piping. The first is the possibility of mechanical fatigue and subsequent crack initiation due to thermal striping, in which temperature fluctuation occur at the interface between two fluid jets at different temperatures. Fluid dynamics simulations of the reactor vessel can partially predict these effects, and they will be further tested via experiment in the early stages of the work.

The second concern relates to welding and joining issues in the primary loop. The piping joints are the weakest links in the primary loop, and it is important to make sure that they retain their mechanical and material integrity throughout reactor operation. Furthermore, it is important to ensure that the metal used in brazing or other joining techniques is compatible with the molten salt, and doesn't exacerbate corrosion effects. Prior research shows that nickel-based brazing alloys are compatible with high-temperature molten salts [13].

One benefit is that the molten salt reactor piping and vessel walls are thinner than those of a light water reactor (because of the lower-pressure piping in a molten salt reactor), which reduces the possibility of inadvertently stressing the metal while welding. Welding and joining issues will be tested experimentally in small-scale test loops.

In the future, the reactor may be adapted to use high-temperature ceramics, such as SiC—SiC fiber composites, in place of Hastelloy components. These ceramics are not yet being manufactured on an industrial scale, but will likely be available within 5 to 10 years. Moving from metals to ceramics will allow us to further increase the reactor's operating temperature, thereby increasing the system's thermal efficiency and enabling a broader range of process heat applications.

Neutronics, Fuel Capacity, and Waste Stream

Reactor Neutronics

Molten salt reactors are versatile in terms of fuel: they can be powered by a range of different fissionable materials, including uranium, plutonium, and thorium. Although Transatomic Power's approach could potentially be used with thorium, we are initially focused on the uranium-plutonium cycle. This fuel cycle allows us to power the reactor with either uranium from an existing industry supply chain or, ideally, to use a fleet of TAP reactors to consume and substantially eliminate the nation's stockpiles of SNF.

Conventional wisdom holds that only a fast reactor can effectively burn SNF. This statement, however, assumes a system in which solid nuclear fuel must be regularly replaced due to the build-up of fission product gases and radiation damage. Under these assumptions, only fast reactors have neutron economies that can destroy enough actinides during a fairly short window of time. In a fast reactor, this actinide burning is accomplished by keeping neutrons at high kinetic energies, where the fission-to-capture ratio is high, with the drawback that the reactor core is exposed to extremely challenging radiation damage.

There are other ways of achieving a neutron spectrum capable of burning SNF. For example, thermal-spectrum CANDU reactors are able to run on spent nuclear fuel by using on-line refueling and a more efficient moderator (heavy water instead of light water) to reduce neutron capture. However, burnup in CANDUs is also limited by the accumulation of fission product poisons that are trapped in the fuel rods. The TAP reactor circumvents this limitation by continuously removing fission products from its liquid fuel.

As described previously, the Transatomic Power reactor burns the same fuel for decades. The combination of the TAP reactor's particularly efficient neutron economy, which allows it to run on fuel with very low enrichment levels, and molten salt reactors' general ability to continuously remove fission products from the fuel are what together enable us to destroy SNF. More generally, they allow us to achieve high efficiency for a clean and complete burn with very little waste.

FIG. 7 compares the neutron energy spectra in an unmoderated molten salt reactor, one moderated with ZrH1.6, and one moderated with graphite. The reactor moderated with ZrH1.6 has significantly more neutrons in the thermal region, defined as neutrons with energies less than approximately 1 eV, thereby allowing it to generate power from low-enriched uranium or spent fuel using the U—Pu fuel cycle. The epithermal (approximately 1 eV-1 MeV) spectrum is lower than that of graphite, but still sufficient to contribute to waste burning. The fast spectrum (greater than 1 MeV) for the zirconium hydride moderated reactor is greater than that of the graphite moderated reactor, and therefore contributes strongly to waste burning.

Fuel Capacity and World Uranium Reserves

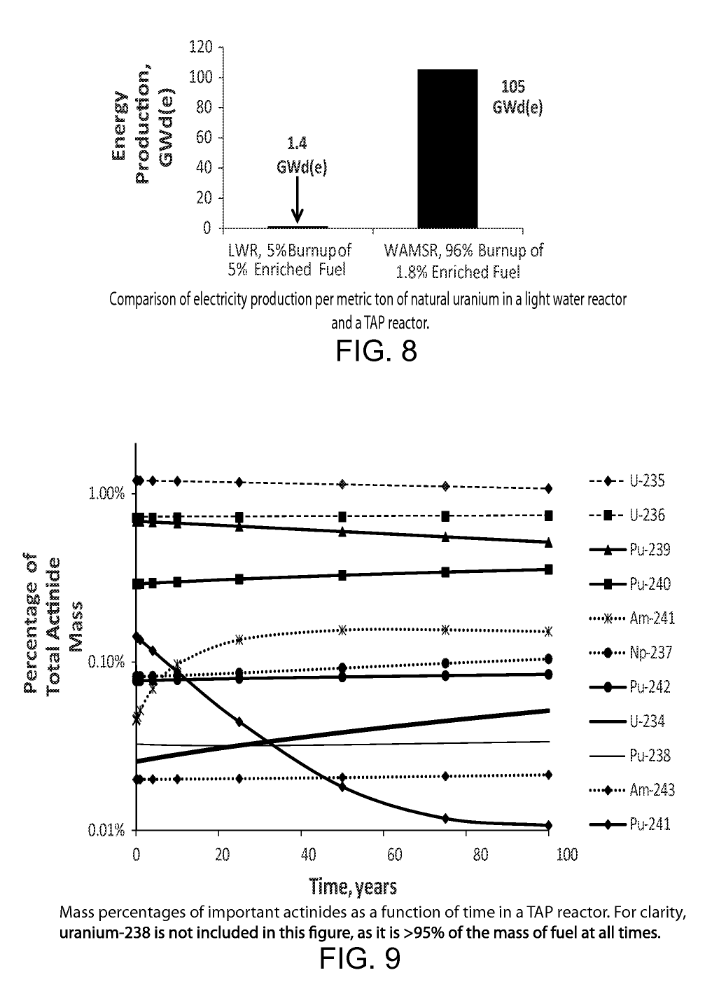

When running on fresh fuel, the TAP reactor is able to generate up to about 75 times more electricity than a light water reactor per kilogram of natural uranium ore, as shown in FIG. 8.

There are three factors driving this higher electricity output: lower enrichment, higher burn-up, and better conversion of heat to electricity:

Lower Enrichment: One ton of natural uranium ore yields 88 kilograms of LWR fuel enriched to 5%. However, it yields 274 kilograms if only enriched to 1.8%. This is a factor of 3.1× more starting fuel mass for the TAP reactor.

Higher Burn-up: At 5% enrichment, lightwater reactors have improved their burnups from from 30 Gigawatt-days per metric ton of heavy metal (GWd per MTHM), and are quickly approaching burnups as high as 45 GWd per MTHM. In contrast, the TAP reactor can achieve up to 96% burnup at 1.8% enrichment—the equivalent of 870 GWd per MHTM out of a theoretical maximum of 909 GWd per MHTM. This is a factor of 19.2× more thermal energy for the TAP reactor.

Better Conversion: Light water reactors have outlet temperatures of 290° C.-330° C., and typical thermal efficiencies of about 34%. TAP reactors have an outlet temperature over 650° C. with a gross thermal efficiency of about 44%. This is a factor of 1.3× more for the TAP reactor.

Proven world reserves of uranium are estimated to be about 6 million metric tons if the market price were $250 per kilogram (current prices are about $130 per kilogram—at a higher price more mines are viable). Using light-water reactors, these reserves are only enough for about three million terawatt-hours of electricity. However, the world consumes about 20,000 terawatt-hours of electricity annually, and this rate is set to triple by 2030 as we climb toward a steady global population of ten billion people. LWRs can therefore only fully supply world electricity needs for about 50 years, even at twice today's uranium prices.

This limitation is currently not an alarming problem because, at this point, nuclear power provides only 12% of global electricity generation—there are several centuries of uranium available at this current generation rate. If, however, nuclear power's generation share increases as countries turn away from fossil fuels, LWRs comparatively low burnups may become an issue. By comparison, the TAP reactor can use current known uranium reserves to supply 100% of the world's electricity needs for 3,500 years.

Techniques now under research around the world for collecting uranium from seawater are estimated to become economically viable once uranium reaches a price of about $300 per kilogram. The TAP reactor generates enough electricity per kilogram of fuel that it remains commercially viable even with extremely high uranium prices. The TAP reactor can therefore enable a greater degree of energy dependence for nations without significant domestic uranium production, such as France, Japan, South Korea, UK, Spain, Argentina, and India. (Key uranium exporters today are Australia, Kazakhstan, Russia, Canada, and Niger.) Higher prices could also justify further exploration to grow reserves.

In short, the TAP reactor enables known uranium reserves to be mankind's long-term solution to an abundant, cheap supply of clean electricity.

Waste Stream

The TAP reactor greatly reduces waste as compared to conventional LWRs, whether it is running on SNF or low-enriched fresh fuel. FIG. 9 shows the time evolution of the actinides present in the TAP reactor starting from an initial load of SNF. As shown, the majority of the isotopes remain essentially in a steady state across many decades. The increases in U-236 and Pu-240 are welcome from an anti-proliferation standpoint, because these isotopes tend to capture neutrons in a nuclear weapon, retarding detonation.

A 520 MWe light-water reactor would contain approximately 40 tons of fuel and generate 10 metric tons of SNF each year. The SNF contains materials with half-lives on the order of hundreds of thousands of years. Although reprocessing methods are available for partially reducing the waste mass, they are currently cost prohibitive and accumulate pure plutonium as a byproduct.

A basic mass flow and waste composition for a 520 MWe TAP reactor are as follows: The reactor starts with 65 tons of actinides in its fuel salt. Each year, 0.5 tons of fission products are filtered from the system and a fresh 0.5 tons of fuel is added, keeping the fuel level steady. At reactor end of life, the inventory of fuel remaining in the reactor may be transported for use in another TAP reactor. Alternately, it may be casked and stored in a repository.

A breakdown of the methods and approximate quantities removed per year by one 520 MWe plant is shown in Table 1.

Gases: The fission products krypton and xenon are removed in the form of a gas, via an off-gas system, and are compressed and bottled on site. Trace amounts of tritiated water vapor are removed and bottled via the same process. A small fraction of the noble fission products are removed directly via the off-gas system.

Solids: Noble and semi-noble metal solid fission products, as well as other species that form colloids in the salt, are removed from the salt as they plate out onto a nickel mesh filter located in a sidestream in the primary loop.

Dissolved lanthanides: While they are less serious factors than krypton and xenon, it is desirable to remove lanthanides from the fuel salt for best operation. We have several options here. Our current approach is to remove lanthanide fission products via a liquid-metal/molten salt extraction process being developed by others in the USA and France. This process can ultimately convert the dissolved lanthanides into an oxide waste form. This waste form is fairly well understood, because spent nuclear fuel from LWRs is in oxide form. This oxide waste comes out of the processing facility in ceramic granules and can be sintered into blocks or any other form convenient for storage.

TABLE 1
Fission product removal methods and approximate average
removal rate. Adapted in part from [14].

| | | Approximate | |
|---|---|---|---|
| | | removal | |
| | | rate, kg | |
| Fission Product | Removal Process | per year | Waste Form |
| Kr, Xe, tritiated | Helium sparging via | 100 | Compressed, |
| water vapor | off-gas | | bottled gas |
| Zn, Ga, Ge, As, Se, | Plating and | 200 | Metallic |
| Nb, Mo, Ru, Rh, | filtration, some | | |
| Pd, Ag, Tc, Cd, In, | removal via off- | | |
| Sn, Sb, Te | gas | | |
| Zr | Molten salt/liquid | 200 | Solid oxides |
| Ni, Fe, Cr | metal extraction | | |
| Np, Pu, Am, Cm | | | |
| (trace) | | | |
| Y, La, Ce, Pr, Nd, | | | |
| Pm, Gd, Tb, Dy, | | | |
| Ho, Er, Sm, Eu | | | |
| Sr, Ba, Rb, Cs | | | |

Compared to a similarly-sized light-water reactor, the annual waste stream is reduced from 10 to 0.5 metric tons—which is 95% less waste. Furthermore, the vast majority of our waste stream—the lanthanides, krypton, xenon, tritiated water vapor, noble metals, and semi-noble metals—has a relatively short half-life decay, on the order of a few hundred years or less. We believe mankind can tractably store waste materials on these timescales, compared to the hundreds of thousands of years required for waste from LWRs.

Of the 200 kilogram lanthanide mass removed by liquid metal extraction, we estimate that approximately 20 kilograms will be actinide contaminant with a longer half-life similar to SNF. It may be most practical to leave such a small quantity embedded in the ceramic granules, as it would be well distributed and would not materially extend the time for the overall waste form to reach background levels. If desired, however, the actinides can be further separated with additional post-processing techniques.

In summary, compared to a light-water reactor, the TAP reactor emits 95% less waste, with an overall waste storage time of a few centuries instead of hundreds of thousands of years.

Better Inherent Safety

Molten salt reactors are a win for public safety. The main concern in a nuclear emergency is to prevent wide-spread release of radioactive materials. The TAP reactor's materials and design greatly reduce the risk of reactor criticality incidents, shrink the amount of radioisotopes in the primary loop, eliminate driving forces that can widen a release, and provide redundant containment barriers for defense in depth.

Self-Stabilizing Core

Like light-water reactors, molten salt reactors have a strong negative void coefficient and negative temperature coefficient. In molten salt reactors, these negative coefficients greatly aid reactor control and act as a strong buffer against temperature excursions. As the core temperature increases, the salt expands. This expansion spreads the fuel volumetrically and slows the rate of fission. This stabilization occurs even without operator action and does not require control rods to function.

Control rods are included in our design to aid in power-up and can be used to SCRAM the core. Molten salt reactors, however, are operator-controlled primarily via the turbine and not by control rods. Slowing the turbine extracts less heat from the salt, thereby increasing its temperature, which in turn decreases reactivity. Once the reactor reaches the lower power level where heat produced is equal to the turbine heat draw, the system re-stabilizes. It is not possible to have a runaway reaction due to increasing the cooling level too rapidly via the turbine—drawing too much heat from the core too freezes the salt. These dynamics provide tight negative feedback loops and give the system inherent stability.

Although the TAP reactor is meant for baseload operation, the ability to control heat output via the turbine enables load following operation.

Smaller Inventory of Radionuclides

As shown in Table 2, a typical 1 GWe light-water reactor core has an inventory of 2 to 7 tons of radionuclides that may conceivably escape during accident conditions. By convention, these core inventory numbers do not include uranium.

These are core inventories that are used to calculate source terms for radionuclude releases in various accident scenarios. However, some accidents such as Fukushima extend to the SNF pool. If a large SNF pool is assumed, then the total plant-wide radionuclide inventory may exceed 30 tons.

A 520 MWe TAP reactor maintains far less source material on hand, because it is much more fuel-efficient than an LWR. Furthermore, noble gases, noble metals, and lanthanides are removed continuously from the system, as shown previously in Table 1. Our radionuclide inventory is therefore just 0.9 tons in a 520 MWe reactor, which is significantly less than what would be present in a similarly-sized light-water power plant. This reduction shrinks the maximum size of a potential release.

Table 2. Radionuclide inventories (normalized to 100 MWe, net generation) in the primary loop for BWR, PWR, and TAP reactor accident analyses. BWR and PWR numbers, chemical groups, and elements in the groups are adapted from [15]. Following [15], LBU indicates an average burnup of 28 GWd per MTHM and HBU indicates an average burnup of 59 GWd per MTHM.

TABLE 2
Radionuclide inventories (normalized to 100 MWe, net generation) in the primary loop for
BWR, PWR, and TAP reactor accident analyses. BWR and PWR numbers, chemical groups, and
elements in the groups are adapted from [15]. Following [15], LBU indicates an
average burnup of 28 GWd per MTHM and HBU indicates an average burnup of 59 GWd per MTHM.

| | | Peach Bottom Unit 3 | | Sequoyah Unit 1 | | |
|---|---|---|---|---|---|---|
| | | (1138 MWe BWR), | | (1148 MWe PWR), | | TAP Reactor |
| | Elements in the | kg per 100 MWe | | kg per 100 MWe | | (520 MWe MSR), |
| Chemical Group | Group | LBU | HBU | LBU | HBU | kg per 100 MWe* |
| Noble Gases | Kr, Xe | 32 | 77 | 26 | 45 | <0.1 |
| Halogens | Br, I | 1 | 3 | 1 | 2 | <0.1 |
| Alkali Metals | Rb, Cs | 18 | 44 | 14 | 25 | 3 |
| Tellurium Group | Se, Sb, Te | 3 | 7 | 2 | 4 | <0.1 |
| Alkaline Earths | Sr, Ba | 14 | 33 | 11 | 19 | 8 |
| Noble Metals | Co, Mo, Tc, Ru, | 44 | 112 | 18 | 32 | <0.1 |
| | Rh, Pd | | | | | |
| Lanthanides** | Y, Nb, La, Pr, Nd, | 43 | 109 | 34 | 61 | 22 |
| | Pm, Sm, Eu, Am, | | | | | |
| | Cm | | | | | |
| Cerium Group | Zr, Ce, Np, Pu | 106 | 201 | 85 | 126 | 137 |

| | | | | | |
|---|---|---|---|---|---|
| Total | 261 | 586 | 191 | 314 | 170 |
| (kg per 100 MWe) | | | | | |
| Total | 2968 | 6665 | 2196 | 3600 | 884 |
| (kg in Entire Plant) | | | | | |

*Steady-state values in the primary loop, assuming fission product removal as described above.
**By convention in NUREG-1246, Cm and Am are placed in the lanthanide group.

Reduced Driving Force

As described in some detail in our comparison of solid and liquid fuels, light-water reactors can experience enormous driving forces during accident scenarios. These forces can come from a hydrogen explosion, a steam explosion, or in some reactors, a high system pressure of 150 atmospheres.

The chance of a high driving force is greatly reduced in a molten salt reactor, because it operates at near-atmospheric pressures, and there is little chance of a vapor explosion. The highest pressure element is the steam turbine. Nuclear reactors already protect against an upstream pressure transient—such as a turbine break—using rupture disks, a passive safety feature that reduces system pressure without any external action required. We adopt the same approach to protect the nuclear island in the TAP reactor.

Passive Safety and Inherent Resistance to Beyond-Design-Basis Events

A significant vulnerability common to all currently operating commercial light-water reactors is that they require a continuous supply of electricity to pump coolant over their core to prevent a meltdown. By definition, a passively safe nuclear reactor is one that does not require operator action or electrical power to shut down safely in an emergency. It is a further goal that the reactor be able to safely cool during a station blackout without any outside emergency measures. An inherently safe reactor will be able to achieve these goals even in the face of an unanticipated or beyond-design basis event.

No reactor design assures perfect safety. However, the TAP reactor is a major advance over light-water reactors because it is passively safe (primarily due to its freeze valve) and can passively cool its drained core via cooling stacks connected to its auxiliary tank, as described above. If the freeze valve fails, the control rods may be inserted by operator action or passively via an electromagnetic failsafe, thereby making the reactor subcritical. If the control rods or other active measures cannot be used, the hot fuel salt will simply remain in the reactor vessel. Heat will cause the salt to expand, thereby reducing reactivity. If the freeze valve fails and the salt continues to increase in temperature, the zirconium hydride moderator rods will decompose. The lack of neutron moderation brings the reactor to a sub-critical state.

If the salt increases in temperature enough to induce material failure in the vessel, then the salt will flow via gravity into a catch basin, shown in FIG. 2, located immediately below the vessel. The catch basin in turn drains via gravity into the auxiliary tank. The reactor and its catch basin are sealed within a concrete chamber only accessible by hatch. Thus, even in this worst-case accident scenario, the system is confined, non-flammable, and shuts down passively.

If fuel salt through some further circumstance escapes the primary containment surrounding the primary loop, it will still be inside the concrete secondary containment structure, which is located at least partially below grade. An intermediate loop creates a buffer zone between the radioactive materials in the reactor and the non-radioactive water in the steam turbine. The steam is at a higher pressure than the intermediate loop and the intermediate loop is at a higher pressure than the primary loop, so that any leaks in heat exchangers will cause a flow toward the core rather than out of the core. Any small counter-pressure flow across the primary heat exchanger is trapped in the intermediate loop. The intermediate loop feeds into a steam generator, and both are also within the concrete secondary containment structure. If the fuel salt, despite all existing safety mechanisms in the system, escapes the containment structure, it will return to solid form once it cools below approximately 500° C.

Table 3 summarizes how fundamental material choices affect key safety aspects for light-water and TAP reactors. TAP reactors have greater inherent safety, which is particularly important for unanticipated and beyond design-basis accidents.

TABLE 3
Inherent Safety for Light-Water and TAP Reactors

| | 1 GWe LWR | 520 MWe TAP |
|---|---|---|
| Negative Void | Yes | Yes |
| Coefficient | | |
| Negative Temperature | Yes | Yes |
| Coefficient | | |
| Moderator Failsafe | Water drains or | Moderator rods lose |
| | boils off | function at high heat |
| | | due to marginal loss |
| | | of hydrogen |
| Radionuclide | 2-30 tons onsite | <1 ton onsite |
| Inventory | | |
| Driving Force/ | 150 atmospheres | 1 atmosphere |
| System Pressure | | |
| Driving Force/ | Peak fuel temperature is | Peak fuel temperature |
| Coolant | 1900° C. above coolant | is 500° C. below |
| | boiling point; steam | boiling point; wide safety |
| | explosion risk | margin |
| Driving Force/ | Peak fuel temp is | Peak fuel temperature |
| Runaway Exothermic | 800° C. above | is 500° C. below |
| Hydrogen Generation | exothermic generation | exothermic generation |
| | point; fire | point; wide safety |
| | explosion risk | margin; no water in core |

Table 4 compares the physical barriers for a light-water reactor and a TAP reactor. The TAP reactor has no fuel cladding because it uses liquid fuel. Auxiliary support to the vessel and cooling boundary is provided by a passive freeze plug, which drains the fuel from the vessel into an underground auxiliary tank during emergency conditions. An additional boundary is provided around the vessel and cooling system with a catch basin and an intermediate cooling loop.

TABLE 4
Physical Barrier Comparison

| | LWR | TAP |
|---|---|---|
| Fuel Material Barrier | Oxide matrix | Salt carrier solidifies |
| | | <500° C. |
| Cladding Barrier | Zirconium cladding | — |
| Vessel and Cooling | Stainless steel | Hastelloy-N vessel and heat |
| Boundary | vessel and | exchanger |
| | heat exchanger | |
| Auxiliary Tank | — | Freeze plug passively drains |
| | | fuel to underground auxiliary |
| | | tank |
| Primary Containment | Yes | Yes |
| Structure | | |
| Catch Basin and | — | Yes |
| Intermediate Loop | | |
| Secondary | Yes | Yes |
| Containment | | |
| Structure | | |
| Exclusion Zone | Yes | Yes |

In sum, today's nuclear plants are designed such that an explosion or steam rupture could have wide area consequences, but safety is assured probabilistically through the use of multiple independent systems of redundant function, adding cost and complexity. TAP reactors draw on these redundant system techniques in places, but we ultimately provide a more resilient safety foundation—molten salt is inherently less capable of a wide-area public disaster.

Reactor Cost

There are a range of commercial power plants that can be envisioned using Transatomic Power's technology. We worked with Burns & Roe, an experienced nuclear engineering, procurement, and construction firm, on a system-wide pre-conceptual plant for a 550 MWe (gross generation) TAP reactor, with a net output of 520 MWe.

Such a plant would serve a gap in the market—today's most modern light-water reactors are typically large units aimed at 1000 MWe and above; a recent push to develop small modular reactors (SMRs) is aimed primarily at 300 MWe and below. The 520 MWe size may be particularly attractive to utilities because it is sized similarly to aging coal plants. The overnight cost for an nth-of-a-kind 520 MWe size was estimated at $2.0 billion with a 3-year construction schedule.

The TAP reactor can realistically achieve these overnight costs because the outlet temperature of 650° C. allows for higher thermal efficiency than current LWR temperatures of 290-330° C., enabling a significant savings in the turbine and balance of plant. There are additional savings because (1) the reactor and heat transfer equipment operate near atmospheric pressures, reducing complexity and expense for both equipment and structures; and (2) the TAP reactor does not need onsite SNF underwater storage with its associated water treatment, leak detection, backup water, and backup generator systems.

There are several cost disadvantages for the TAP reactor that were anticipated in this analysis as well. We need to keep our piping warm to prevent salt freeze-outs. We must contend with tritiated water vapor capture at high temperatures. We use an intermediate loop filled with non-radioactive salt to separate the steam cycle from the fuel-salt. We also require structural space for fission product removal. Nevertheless, the analysis shows these cost additions are greatly outweighed by the savings described above.

The $2 billion price point can greatly expand the demand for nuclear energy, because it is a lower entry cost than large-sized nuclear power plants, which are usually well above $6 billion and take longer to construct than the smaller TAP reactor. A lower price for a smaller unit will expand the number of utilities that can afford to buy nuclear reactors, better match slow changes in demand, allow greater site feasibility, and reach cashflow breakeven faster. The speed of construction and faster payback also reduce financing costs.

TAP reactors will also deliver a low levelized cost of electricity (LCOE). While most observers assume nuclear fuel costs are near zero, the Nuclear Energy Institute estimates the 2011 cost was actually 0.68 cents per kilowatt-hour. As the above fuel cycle figures illustrate, we expect to produce far more electricity per ton of ore than the current fuel cycle, driving these costs down toward zero. The TAP reactor is refueled continuously for a high uptime. Finally, the 520 MWe size will absorb overheads better than smaller SMRs.

Lowering the Hurdles for a U.S. Repository

The United States has set aside a $30 billion trust for a repository and has 64,000 tons of SNF to store—approximately $500 per kilogram of SNF. However, our country has not been able to agree on a location or final design for the repository.

Why not reprocess? The cost to reprocess as the French do is about $1,000 per kilogram of SNF, which is well above what is available in the U.S. Waste Disposal Trust Fund. Meanwhile, SNF can be held inside existing wet storage pools at near-negligible cost. As pools fill up, SNF older than 3-10 years can be dry casked for roughly $100 per kilogram and stored for up to 40 years, making this method a cost-effective stopgap. About one-quarter of US SNF has been dry-casked. The other 48,000 tons remain in wet pools, adding to the plant inventory of radionuclides described in Section 3.2.

The TAP reactor can use fresh uranium fuel or SNF. Utilities can buy fresh uranium from commercial suppliers. The business case for a utility using SNF is somewhat more complicated, because the SNF requires additional handling costs as compared to fresh fuel. The plant must (1) transport and receive the radioactive spent fuel rods, (2) remove the cladding physically, and (3) dissolve the uranium oxide into the molten salt or convert it to a gas that can be injected into the molten salt. The techniques are well known because the same three initial steps must be employed in reprocessing plants such as at Le Havre in France or similar facilities existing at the Idaho National Laboratory [8]. We avoid, however, all of the remaining chemical steps that are the main cost drivers of the work. If reprocessing costs $1000 per kilogram, we could potentially perform just the initial steps for a fractional amount, perhaps in a small number of regional facilities that ship fuel directly to TAP reactors. Our initial assessment is that a disposal charge of $500 per kilogram of SNF is achievable, affordable, and more cost-effective than reprocessing and would be within the budget allowed by the U.S. Waste Disposal Trust Fund.

The existing 64,000 tons of SNF contain an enormous amount of energy. If all U.S. light-water plants were replaced tomorrow by TAP reactors, it would still take 350 years to consume all of the existing SNF. Even if we expand the role of nuclear by also converting all coal plants to TAP reactors, we could still run for 150 years. The SNF needs to be stored in the meantime. Furthermore, the TAP reactors would themselves create small amounts of waste to store. We therefore cannot use TAP reactors to avoid a U.S. repository entirely. TAP reactors do, however, allow us to build a smaller and simpler repository. SNF would only need to be stored for a few hundred years instead of hundreds of thousands of years. Furthermore, by avoiding a great deal of future SNF, we may avoid the need to build a second or third repository.

Anti-Proliferation Analysis

The TAP reactor represents a major victory for non-proliferation, because it cuts future production of SNF while slowly reducing SNF stockpiles from the past.

Today, the world's main tool to block plutonium proliferation is to guard irradiated materials. Light-water reactors are, however, a troubling contributor to the problem. One ton of SNF contains enough Pu-239 for one atomic bomb [16], and the world has accumulated 270,000 tons of commercial SNF. This figure is growing by some 10,000 tons per year, and is further accelerating as the rest of the world builds more light-water nuclear power plants in more countries. Starting up a typical 1 GWe light-water reactor in a foreign country requires 90 tons of initial fuel, and a further 20 more tons of fuel, on average, for each year that the reactor is in operation. After 60 years, the foreign country has 1200 tons of SNF—enough for a weapons program to build over one thousand atomic bombs. The foreign SNF must therefore be guarded in perpetuity, and it is forever a threat to become the materials source for a weapons arsenal if the state goes rogue or if the material is stolen.

Our design is proliferation resistant because no process preferentially removes or extracts any isotope, and the facility does not enrich source material. We do not separate pure uranium or pure plutonium or any precursor of pure uranium or plutonium. The source material is at high temperature and diluted across the molten fluoride salt, making theft impractical.

There are three separate waste streams emerging from the TAP reactor. The first is from a continuously-operating off-gas system that removes contaminants, including fission products, fission product daughters, water, oxygen, and small amounts of tritiated water vapor, from the primary loop. The second waste stream is composed of the noble and semi-noble metals that plate onto a mesh filter located in the primary loop. Neither contains any source material useful for atomic weapons.

The third waste stream is made up of lanthanide fission products. We remove these fission products using molten salt/liquid-metal extraction, a process under development by others in France and the USA. We use this method because it is highly effective at removing lanthanides with minimal actinide contaminants in the waste stream, and never separates pure plutonium or uranium. Furthermore, most of the separation steps occur in counter-flow columns that would be complex to modify. The two final steps use electrochemistry: one removes minor actinides from a liquid metal stream, and the other removes lanthanides from the liquid metal stream. As discussed previously, the lanthanide waste stream ultimately emerges an as oxide that can be sintered into blocks or other solid shapes suitable for storage.

Despite the efficiency of the process, the lanthanide waste stream of 200 kilograms per year is contaminated by detectable levels of actinides, approximately 20 kilograms total, including small amounts of uranium and plutonium. The uranium contaminant is at 1.8% enrichment, and is therefore not a proliferation concern. Less than 0.1% of the lanthanide waste stream is plutonium contaminants—a factor of 10 reduction compared to LWR spent fuel, which is approximately 1% plutonium. The lanthanide fission product waste stream would therefore not be a practical source of weapons materials for a rogue state.

Finally, we note that the several countries are currently struggling to handle their stockpiles of plutonium. Plutonium is isolated as a by-product during the reprocessing techniques used in France, the UK and elsewhere. Due to the versatility of molten salt reactors, future TAP reactors could burn this plutonium after it is downblended and mixed with natural uranium. Directly reducing stockpiles of weapons plutonium is a significant anti-proliferation benefit.

Comparison to Other Waste-Burning Reactors

Several advanced fast reactor concepts have also been proposed to burn waste. However, fast reactors have proven difficult to scale up despite major past investments. All fast reactors are challenged by high neutron fluence—an order of magnitude higher than traditional reactors—and the resulting damage that occurs to vessels and equipment.

Fast reactors also face proliferation concerns because they can produce excess plutonium during operation. Some fast reactors handle this issue by sealing the reactor so that there is no external access to the core, but this lack of access increases the materials challenges of the design even further. Additionally, some fast reactors have a fire risk due to their sodium metal coolant. Molten salt does not have this risk. Molten salt reactors can also be built at considerably lower cost than gas fast reactors.

The TAP reactor aims to close the fuel cycle with a commercially viable and scalable technology. We use a thermal spectrum, which reduces component damage as compared to a fast reactor, and we achieve greater inherent safety for the public. The fundamental principles of the design have already been demonstrated at the Oak Ridge National Laboratory. We modify this previous design to yield exciting benefits without demanding dramatically new materials. Our improvements can also be demonstrated at a small scale, reducing development costs. For these reasons, the TAP reactor is the best and most practical concept for closing the nuclear fuel cycle.

Why Not Thorium First?

The TAP reactor's primary innovations—a novel combination of moderator and fuel salt—can also be adapted for use with thorium. Transatomic Power believes that the thorium fuel cycle holds theoretical advantages over uranium in the long run due to its generally shorter half-life waste, its elimination of plutonium from the fuel cycle, and its greater natural supply. However, we chose to start with uranium for several reasons: (1) there is a great deal of spent nuclear fuel, and we want to harness its energy while reducing the risk of onsite SNF storage; (2) the industry already has a commercial fuel cycle developed around uranium; (3) we already greatly eliminate waste; and (4) we already greatly expand the energy potential of existing uranium supplies.

Thorium reactors do not contain plutonium, but they do have a potential proliferation vulnerability due to the protactinium in their fuel salt. Protactinium has a high neutron capture cross section and therefore, in most liquid thorium reactor designs, it must be removed continuously from the reactor. The process for doing this yields relatively pure protactinium, which then decays into pure U-233. By design, the pure U-233 is sent back into the reactor where it is burned as its primary fuel. The drawback, however, is that U-233 is a weapons-grade isotope that is much easier to trigger than plutonium. It is possible to denature the U-233 by mixing it with other uranium isotopes, or modify the design to further reduce diversion risk, but further research is required to implement these anti-proliferation measures in thorium molten salt reactors.

Future Advances

The basic TAP reactor design described in this report will benefit from future innovations in a number of different ways. Improvements to complementary technology will become commercially available over time. These technologies include high temperature ceramics such as SiC—SiC composites for heat exchangers and other reactor internals, which will allow us to increase the reactor's operating temperature and increase thermal efficiency. We will likely be able to incorporate closed loop Brayton cycles once that technology becomes readily commercially available.

As renewables grow more prevalent and grid supply becomes more variable, we may also adapt the plant for better load-following. Molten salt reactors are inherently better able to load-follow than solid-fueled reactors, because the off-gas system prevents the neutron poison xenon from building up in the primary loop. In solid-fueled reactors, decreasing the power level causes an increase in xenon, because xenon is not a direct fission product. Following shutdown, light water reactors require on the order of several days for the xenon to decay enough to allow for restart. Boiling water reactors and advanced boiling water reactors are capable of overnight load following, but this xenon instability can reduce their load following performance by inducing local power peaking in the core. Molten salt reactors do not experience xenon instability, because the off-gas system quickly removes xenon from the primary loop, regardless of power level.

Other small modular reactor designs are capable of a crude type of load following via the following scheme: the power plant consists of an array of reactors in the range of 50-200 MWe, and the individual units are turned off and on depending on power demand. A major drawback of this system is that the multiple stop and restart cycles may damage the reactor components. In contrast, molten salt reactors like the TAP reactor are capable of much more precise and continuous load following.

These technology advances present bright new opportunities for nuclear power. Reliable load following will allow reactors to adapt to daily and seasonal changes in electric demand and take advantage of the corresponding fluctuations in electricity prices. Furthermore, increasing the operating temperature of the plant will allow these reactors to expand into new markets such as process heat and synthetic fuel production.

Conclusions

Transatomic Power's molten salt reactor generates clean, passively safe, and low cost nuclear power from SNF or low-enriched fresh uranium fuel. The most significant differences between this reactor and previous molten salt designs are our zirconium hydride moderator and LiF-(Heavy metal)F4 fuel salt, which allow us to achieve a very high actinide burnup in a compact, cost-effective design.

Previous experimental work in conjunction with the TRIGA and SNAP reactors has shown that zirconium hydride is stable at the temperatures and neutron fluxes present in Transatomic Power's reactor. Other experimental work at the Oak Ridge National Laboratory demonstrated the compatibility of modified Hastelloy-N with molten fluoride fuel salts.

The reactor has a thermal spectrum, which reduces neutron damage to the moderator and other plant components as compared to a fast spectrum, and consequentially lowers the costs associated with component replacement. There are, however, sufficient epithermal and fast neutrons to break down actinides. The reactor is highly proliferation resistant: it requires minimal fuel processing, and never purifies special nuclear materials. Furthermore, this plant possesses the appealing safety benefits common to most molten salt fueled reactor designs. It does not require any external electric power to shut down safely.

The TAP reactor solves some of the most pressing problems facing the nuclear industry—safety, waste, materials proliferation, and cost—and can allow for more widespread growth of safe nuclear power.

### Other Embodiments

A number of embodiments have been described. Nevertheless, it will be understood that various modifications may be made without departing from the spirit and scope of the disclosure. For example, these concepts can be applied to a molten salt reactor whose core is comprised of multiple zones with varying moderator and fuel-salt volume fractions. The purpose of the multi-region core is to increase the conversion ratio (as compared to a core with a uniform moderator volume fraction) while maintaining criticality.

In some implementations, the moderator is comprised of zirconium hydride and a cladding to separate the moderator from the fuel-salt. Zirconium hydride is a very efficient moderator, meaning that it can create a thermalized neutron energy spectrum with a smaller volume than most other moderators. Lithium fluoride actinide fluoride has the advantage of having a higher actinide solubility than most other fuel salts. This combination of moderator and fuel salt enables criticality with a smaller core volume than typical molten salt reactors.

In other implementations the moderator may be graphite, beryllium oxide, metal hydrides, or metal deuterides like zirconium deuteride, amongst others, or any combination of two or more of these moderators. The solid moderator may be in the form of rods, annular rods, finned rods, wire-wrapped rods, spheres or pebbles, large blocks with fuel-salt channels going through the block, plates, assemblies of plates, or any other suitable geometry, or any combination of suitable geometries.

In some implementations, the fuel-salt is comprised of lithium fluoride and actinide fluorides, where actinide fluorides can be a combination of actinide elements, as long as the fuel-salt includes at least one fissile isotope. In other implementations, the fuel-salt may be comprised of actinide fluorides, lithium fluorides, beryllium fluorides, zirconium fluorides, amongst others, or any combination of two of more these salts.

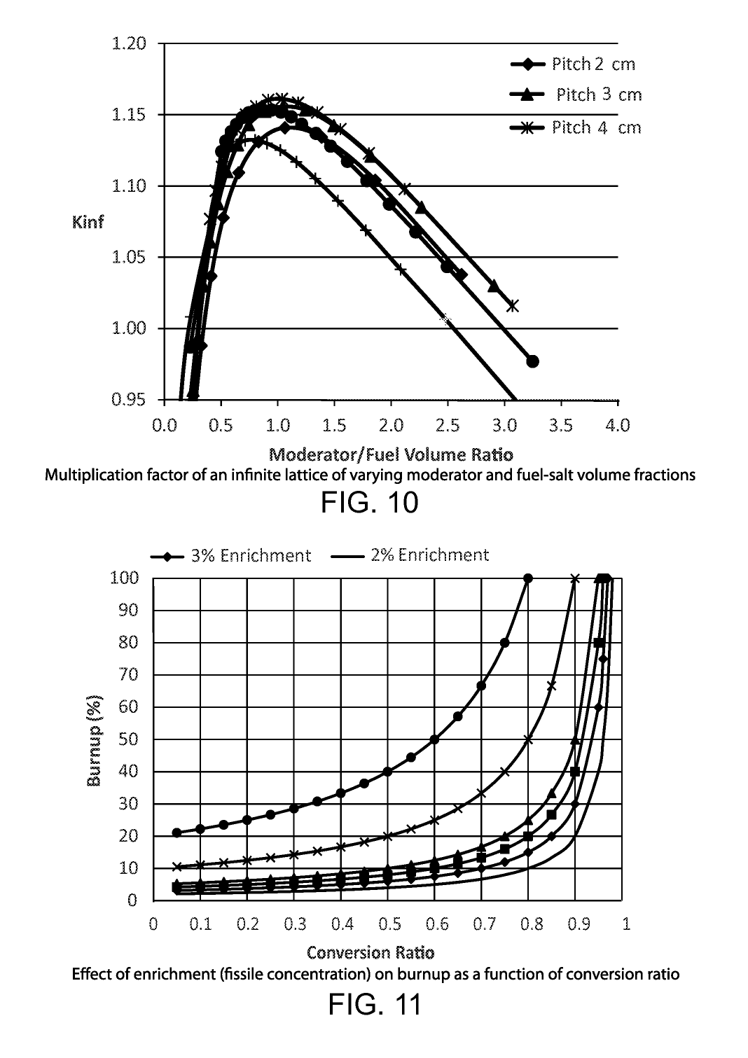

Moderated regions are typically designed to maximize reactivity, which is defined as the positive or negative deviation of the multiplication factor (k) from criticality, which occurs when k=1. FIG. 10 illustrates how the multiplication factor varies as a function of moderator-to-fuel-salt volume fraction in one implementation using a lithium fluoride and actinide fluoride fuel-salt and a zirconium hydride moderator. This figure was generated from simulation of an infinite lattice of fuel-salt and moderator. Pitch is the center-to-center spacing between adjacent rods of moderator. The simulations were performed with MCNP6.

The conversion ratio is typically defined as the ratio of the rate of fissile production to the rate of fissile loss. When the conversion ratio equals one, the rates of fissile production and destruction are exactly equal. In a simplified molten salt reactor system with a conversion ratio equal to one, the fissile concentration can be kept constant over time by continuously feeding a stream of fertile nuclei into the reactor at a rate equal to the rate of fission. (This and subsequent examples assume that all fission products are immediately removed from the system.) If the conversion ratio is greater than one, the fissile concentration will increase over time if fertile nuclei are continuously fed into the reactor. When greater than one, the conversion ratio is called the breeding ratio. If the conversion ratio is less than one, the concentration of fissile nuclei will decrease over time if only fertile nuclei are fed into the reactor. However, if enriched uranium, for example, is fed continuously into the simplified reactor system, the fissile concentration in the reactor will remain approximately constant if the fissile content of the feed (ffeed) is equal to one minus the conversion ratio (CR):

f_{feed}=1−CR

The burnup (B), or fraction of the actinide fuel that is fissioned, can be approximated with the equation:

$$B = \frac{E}{( 1 - CR )}$$

where the E is the effective enrichment, or percentage by weight of fissile nuclei in the actinide fuel. FIG. 11 shows that to achieve a high burnup, the core must have a high conversion ratio or high enrichment.

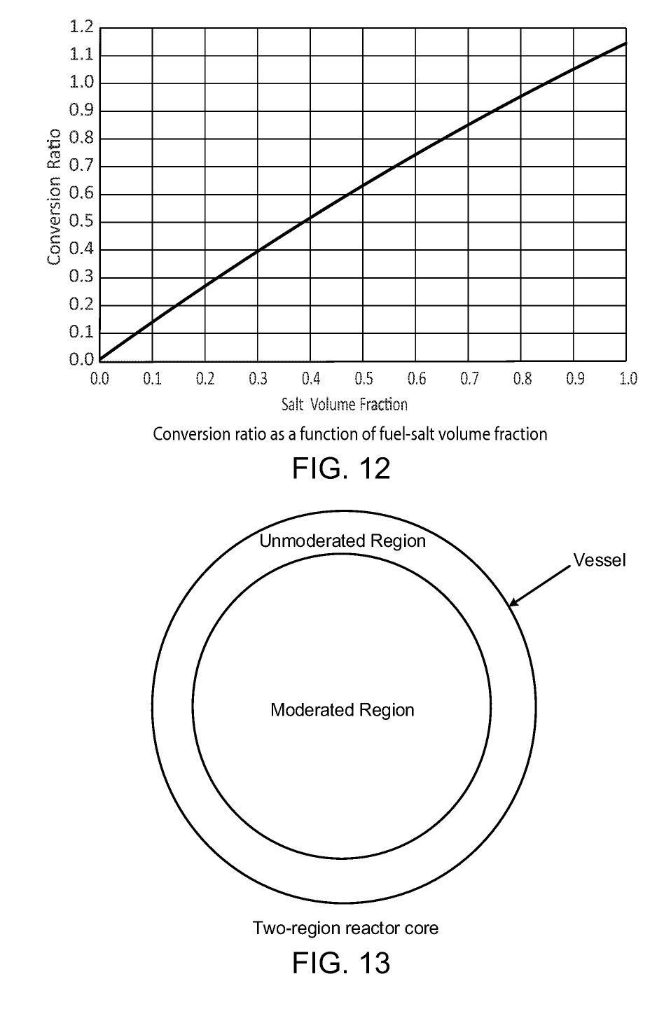

The conversion ratio varies as a function of fuel-salt and moderator volume fractions. FIG. 12 illustrates how the conversion ratio varies as a function of fuel-salt volume fraction in one exemplary implementation. In this example, the entire volume is comprised of either fuel-salt or moderator, so the moderator volume fraction is equal to one minus the fuel-salt volume fraction.

By looking at FIG. 10 and FIG. 12, one can see that the conversion ratio is highest where the entire core volume is fuel-salt and no solid moderator is present. However, the multiplication factor is greatest when the ratio of fuel-salt to moderator is approximately one, meaning there are approximately equal volumes of fuel-salt and solid moderator present in the core. The disclosed reactor incorporates within the core multiple distinct regions with varying volume fractions of solid moderator such that the conversion ratio of the combined regions is greater than that of a core comprised of a uniform lattice of solid moderator and fuel-salt while maintaining a multiplication factor equal to or greater than one.

One exemplary embodiment, illustrated in FIG. 13, is comprised of a central, moderated region surrounded by an outer, unmoderated region. The inner region has fuel-salt and solid moderator volume fractions at or near the combination that maximizes the multiplication factor. FIG. 10 shows that reactivity is maximized when fuel-salt and solid moderator volumes are approximately equal. Therefore, the central, moderated region of this embodiment is comprised of equal volumes of fuel-salt (lithium fluoride, actinide fluoride) and solid zirconium hydride moderator. The outer region is unmoderated (in that it does not substantially contain any solid moderator). The addition of the outer, unmoderated region decreases the multiplication factor of the core, but also increases the overall conversion ratio of the combination of the two regions.

Preliminary analyses with MCNP6 and SCALE 6.1 indicate that a core as depicted in FIG. 13, with a 2 meter diameter central moderated zone (50% moderator, 50% fuel-salt) and a 0.5 meter thick unmoderated region, can achieve a conversion ratio of approximately 0.9 while maintaining a multiplication factor greater than one. Improvements to the conversion ratio are likely possible by increasing the total diameter of the core while also increasing the volume of the unmoderated zone relative to the moderated zone.

Other embodiments may be comprised of a central unmoderated region and an outer, moderated region. Additional embodiments may be comprised of two or more regions, with at least two distinct volume fractions of fuel-salt and solid moderator.

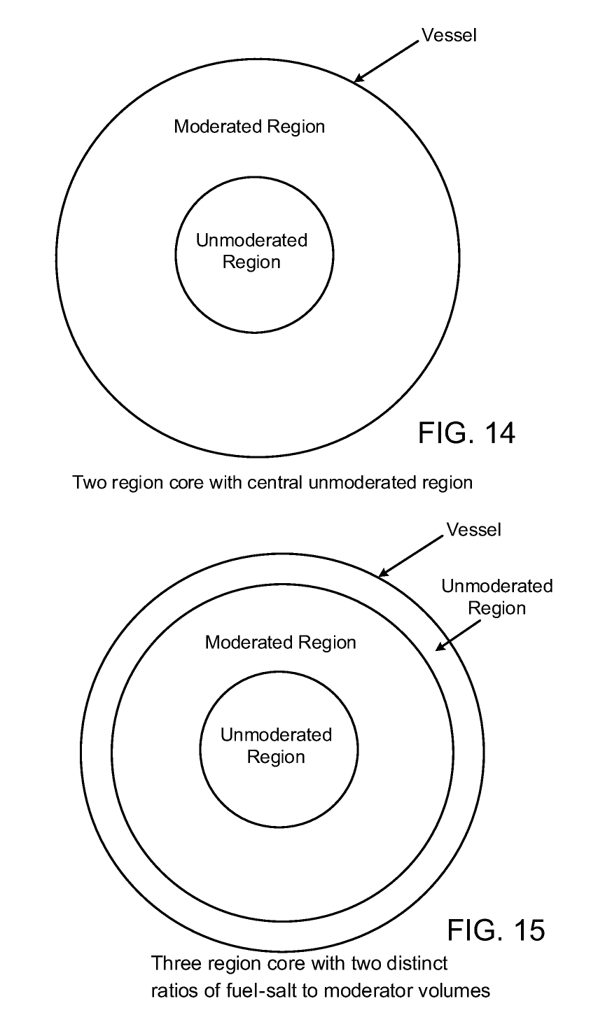

FIG. 14 illustrates a variation of a two region core, with the unmoderated region in the center and surrounded by the moderated region. This configuration may offer a higher conversion ratio than the core in FIG. 13, because the higher scalar neutron flux in the center of the core may increase the rate of fertile-to-fissile transmutation.

FIG. 15 expands upon this concept by adding a second unmoderated region along the periphery of the core. The outer unmoderated region acts as a neutron-absorbing blanket that increases overall conversion ratio, reduces neutron leakage out of the core, and reduces neutron fluence and damage to the vessel wall. Increased neutron absorption in the outer unmoderated region is caused primarily by the increased concentration of U-238, which is a strong neutron absorber in the epithermal energy range.

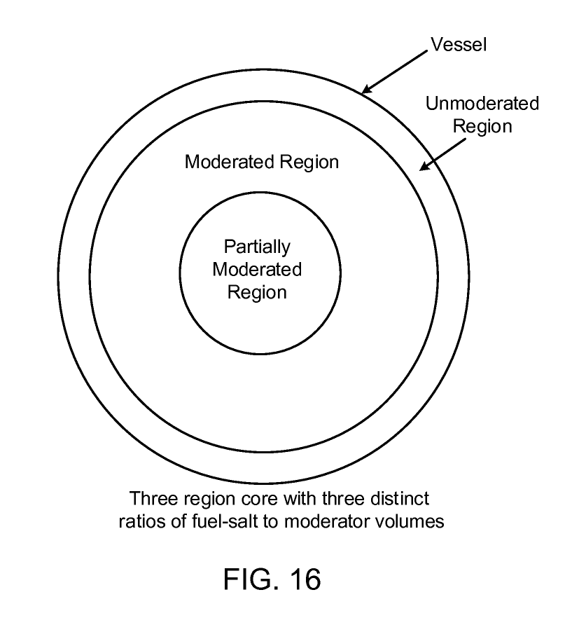

The incorporation of a central unmoderated region, while increasing the overall conversion ratio of the core, also causes a decrease in the multiplication factor. To reduce the detrimental effect on the multiplication factor, the central region can be designed to have volume fractions of fuel-salt and moderator between fully unmoderated to the configuration that maximizes the multiplication factor (approximately 50% fuel-salt, 50% moderator). FIG. 16 illustrates one implementation of this design, which has an outer unmoderated region, and central slightly moderated region, and a moderated middle region.

Accordingly, other embodiments are within the scope of the following claims.

### REFERENCES

[1] P. N. Haubenreich, Molten Salt Reactor Experiment, ORNL-4449 (1970).
[2] US DOE Nuclear Energy Research Advisory Committee and the Generation IV International Forum, A technology roadmap for generation IV nuclear energy systems. GIF-002-00 (2002).
[3] L. Dewan, Molecular Dynamics Simulation and Topological Analysis of the Network Structure of Actinide-Bearing Materials, MIT Doctoral Dissertation, Department of Nuclear Science and Engineering (2013).
[4] O. Benes, R. J. M. Konings, Molten Salt Reactor Fuel and Coolant, Comprehensive Nuclear Materials. 3 (2012) 359-389.
[5] J. Buongiorno, J. W. Sterbentz, P. E. MacDonald, Study of solid moderators for the thermal-spectrum supercritical water-cooled reactor, Nucl Technol. 153 (2006) 282-303.
[6] M. Simnad, The UZrHx alloy: Its properties and use in TRIGA fuel, Nucl. Eng. Des. 64 (1981) 403-422.
[7] K. Moore, Phase relationships in the α+δ region of the Zr—H system, J. Nucl. Mater. 32 (1969) 46-56.
[8] J. Huangs, B. Tsuchiya, K. Konashi, M. Yamawaki, Estimation of hydrogen redistribution in zirconium hydride under temperature gradient, J Nucl Sci Technol. 37 (2000) 887-892.
[9] N. Ponomarev-Stepnoi, V. Bubelev, E. Glushkov, V. Garin, N. Kukharkin, G. Kompaniets, V. Nosov, E. Chunyaev, Estimation of the hydrogen emission from a hydride moderator by measuring the reactivity and using mathematical statistics, Atomic Energy. 102 (2007) 87-93.
[10] K. Terrani, M. Balooch, D. Wongsawaeng, S. Jaiyen, D. Olander, The kinetics of hydrogen desorption from and adsorption on zirconium hydride, J. Nucl. Mater. 397 (2010) 61-68.
[11] M. S. El-Genk, Deployment history and design considerations for space reactor power systems, Acta Astronaut. 64 (2009) 833-849.
[12] R. C. Robertson, Conceptual Design Study of a Single-Fluid Molten Salt Breeder Reactor, ORNL-4541 (1971).
[13] H. MacPherson, Molten Salt Reactors, Reactor Handbook. 4 (1964).
[14] D. Holcomb, G. Flanagan, B. Patton, J. Gehin, R. Howard, T. Harrison, Fast Spectrum Molten Salt Reactor Options (2011).
[15] D. Powers, M. Leonard, R. Gauntt, R. Lee, M. Salay, Accident Source Terms for Light-Water Nuclear Power Plants Using High-Burnup or MOX Fuel, SAND2011-0128. Albuquerque: Sandia National Laboratories (2011).
[16] T. B. Taylor, Nuclear safeguards, Annu. Rev. Nucl. Sci. 25 (1975) 407-421.

What is claimed is:

1. A molten salt reactor comprising:
a fluoride fuel salt; and
a metal hydride moderator.

2. The molten salt reactor of claim 1, wherein the reactor runs using fresh uranium fuel with enrichment levels below 30% U-235 (e.g., below 25%, below 20%, below 15%, below 10%, below 5%, as low as 1.8% U-235).

3. The molten salt reactor of claim 1, wherein the reactor runs using the entire actinide component of spent nuclear fuel.

4. The molten salt reactor of claim 1, comprising a primary loop containing the reactor vessel including the metal hydride moderator, pumps, and primary heat exchanger.

5. The molten salt reactor of claim 4, wherein the pumps are operable to continuously circulate the fuel salt through the primary loop.

6. The molten salt reactor of claim 5, wherein the pumps, the reactor vessels, associated tanks, and associated piping are made of modified Hastelloy-N.

7. The molten salt reactor of claim 4, comprising heat exchangers thermally connecting the primary loop with secondary loops.

8. The molten salt reactor of claim 7, wherein the intermediate loops are filled with molten LiF—KF—Na—F (FLiNaK) salt.

9. The molten salt reactor of claim 1, comprising fission product removal systems.

10. A molten salt reactor comprising:
a fluoride fuel salt; and
a metal hydride moderator;
wherein the reactor has a core comprised of multiple zones with varying moderator and fuel-salt volume fractions.

11. The molten salt reactor of claim 10, wherein the core has an unmoderated region surrounded by a moderated region.

12. The molten salt reactor of claim 11, wherein the core has a second unmoderated region surrounding the moderated region.

13. The molten salt reactor of claim 10, wherein the core has an outer unmoderated region, and a central slightly moderated region, and a moderated middle region.
